(19) United States
(12) Patent Application Publication
(10) Pub. No.: US 2020/0334979 A1
(43) Pub. Date: Oct. 22, 2020

(54) PREDICTIVE, INTEGRATED AND INTELLIGENT SYSTEM FOR CONTROL OF TIMES IN TRAFFIC LIGHTS

(71) Applicants: VELSIS SISTEMAS E TECNOLOGIA VIARIA S/A, Curitiba (BR); CINQ TECHNOLOGIES LTDA, Curitiba (BR)

(72) Inventors: Sergio Machado GONÇALVES, Curitiba (BR); Carlos Alberto JAYME, Curitiba (BR)

(21) Appl. No.: 16/085,911

(22) PCT Filed: Apr. 18, 2018
(86) PCT No.: PCT/BR2018/050116

§ 371 Date: Sep. 17, 2018

(30) Foreign Application Priority Data
Sep. 15, 2017 (BR) 10 2017 019865 0

(51) Int. Cl. G08G 1/087; G08G 1/017; H04W 4/21; G08G 1/005

(52) U.S. Cl. CPC G08G 1/087; G08G 1/005; H04W 4/21; G08G 1/017

(57) ABSTRACT

The present invention relates to an intelligent, integrated predictive system for controlling the opening and closing times of traffic lights that control vehicle flow using the set of data and information provided by the various available geoprocessing systems (GPS) and traffic control systems to generate computational intelligence and to adjust the times of each traffic light according to the flow of people and vehicles provided for each intercession. The system The system employs monitoring of “crowdsourcing”/“big data” information systems, intelligent and trainable algorithms for decision making based on “Machine Learning” and “IoT”. A Center supported by artificial intelligence and “big data” interacts with traffic lights, “VMSs”, Smartphones, personal systems, WEB systems, amongst others. This allows lives to be saved, as these vehicles will have their ways cleared from the regular traffic jam.

The present invention relates to an intelligent, integrated predictive system for controlling the opening and closing times of traffic lights that control vehicle flow using the set of data and information provided by the various geoprocessing systems (GPS) and traffic control systems (electronic monitoring and traffic monitoring equipment) to generate computational intelligence and to adjust the times of each traffic light according to the flow of people and vehicles provided for each intercession. The system allows improving the fluidity of vehicles, pedestrians and emergency vehicles on public roads, using available information. This allows lives to be saved, since these vehicles will have their paths clear of normal traffic.

As it is well known by the technical means connected to vehicle traffic control, the current “intelligent” traffic light opening/closing time control systems work with information of the quantity of vehicles on each road forming a intercession, crossing the information to adjust the traffic light times in each traffic session according to the demand. They also consider the daily and hourly history of road traffic and thus design traffic flow and traffic light behavior in each traffic corridor (pathways considered the “arteries” within the road system).

Among the disadvantages of the current systems we can cite:

1) Decisions to adjust traffic lights are based on the momentary flow of vehicles and their history and not on the prediction of the flow that will arrive at each intercession, whether of vehicles and/or pedestrians.

2) There is no interaction between emergency vehicles with traffic lights and with other vehicles, making it difficult to travel in emergency operations.

3) The current sound signals placed at traffic lights are totally inefficient for people with special needs due to hearing, vision and/or locomotion impairing. The main limitation of today's systems is that they can only “see” the past, that is, what has already happened, and “try” to predict the future, which is extremely inefficient, since any additional variable (rain, road construction, accident, maintenance involving total or partial obstruction, volume of vehicles not considered in history, among others), makes the changes in the traffic signal times inefficient and sometimes “catastrophic”, because they generate more congestion.

Searching for in the Brazilian and international patent banks, we find the following revelations of traffic control systems:

Brazilian patent BR 10 2015 0103662 by the present inventor discloses an intelligent control device for traffic lights to dynamically optimize the duration of traffic light states of a road intersection from the flow of vehicles. This device processes information obtained from video surveillance cameras for real-time traffic monitoring and, based on the mass of vehicles present on each of the routes, defines the durations of each state of the signals. The device monitors the traffic constantly in real time, so if the mass of vehicles in one road with the activated red signal becomes larger than the mass of vehicles of the other route, the device initiates the process of state reversal between the traffic lights to balance the percentage of vehicles on hold. This method belongs to the field of computer vision and pattern recognition in images, consisting on the application of a series of processing on the frames obtained from video cameras focused on traffic monitoring;

U.S. Pat. No. 4,390,951 discloses an apparatus designed to monitor traffic on a section of road of given length L for modifying the operation of a traffic light at an intersection approached by that road comprises speed-sensing circuits at opposite ends of the surveyed road section, the entrance-side circuit also emitting pulse trains reflecting the lengths Li of passing vehicles. A calculator determines from the measured entrance and exit speeds a mean overall speed VM which is inversely proportional to the mean transit time L/VM and enables the computation of an occupancy density DE(t)=.SIGMA.Li/L from which in turn an encumbrance P(t)=DE(t)/VM is derived. The traffic light can be controlled directly by a signal which is proportional to this encumbrance P(t), or which represents a related function F(t). An additional modification of the operating cycle of such traffic light can be brought about by a signal indicating the approach of a vehicle of unusual length on the surveyed road section.

U.S. Pat. No. 5,172,113 discloses a method of optically transmitting data from an optical emitter to a detector mounted along a traffic route is used in an optical traffic preemption system. The method allows variable data to be transmitted in a stream of light pulses by interleaving data pulses between priority pulses. By allowing data to be transmitted in a stream of light pulses, an optical emitter constructed in accordance with the present invention transmits an optical signal that can include an identification code that uniquely identifies the emitter, an offset code that causes a phase selector to create a traffic signal offset, an operation code that causes traffic signal lights to assume at least one phase and a range setting code that causes a phase selector to set a threshold to which future optical transmissions will be compared. Phase selectors constructed in accordance with the present invention are provided with a discrimination algorithm which is able to track a plurality of optical transmissions with each detector channel. Optical emitters constructed in accordance with the present invention are provided with a coincidence avoidance mechanism which causes overlapping optical transmission from separate optical emitters to drift apart. The present invention provides an optical signal format that allows variable data to be transmitted, while maintaining compatibility with prior optical traffic preemption systems.

Patent WO2016202009 discloses a road traffic light coordination and control method based on reinforcement learning, comprising: a monitoring device is provided corresponding to each intersection, and each monitoring device is connected to a remote server through a network module. The control method comprises: (1) the remote server calculates a waiting time S by receiving a video signal; (2) the remote server performs analysis to obtain a road congestion condition under each phase state a i; (3) the remote server obtains a feasible degree ci ai under the phase state a i, wherein when a flow of traffic can pass through the road, the road is clear and the feasible degree ci ai is 1; otherwise, the road is congested and the feasible degree ci ai is 0; (4) the waiting time S and the feasible degree ci ai are used to calculate an optimal driving phase state a i of the intersection; (5) adjust the traffic lights. Based on video information acquired in real time and by means of coordination and control of traffic lights of a plurality of intersections in one area, traffic efficiency is improved, the flow of traffic of the area is maximized, and the road traffic congestion condition is alleviated.

Chinese Utility Model Patent CN205722426 relates to a road monitoring field especially relates to an intelligence time delay traffic signal lamp system based on PLC control, intelligence time delay traffic signal lamp system based on PLC control, switch module and traffic light signal lamp module formula switching module including piezoelectric sensor, traffic flow detection circuit, gravity sensor, PLC controller, traffic signal lamp display circuit, traffic light signal lamp indicating, gravity sensor pass through traffic light signal lamp module formula switch the module with the input of PLC controller links to each other, piezoelectric sensor pass through the traffic flow detection circuit with the input of PLC controller links to each other, the traffic signal lamp display circuit pass through traffic light signal lamp indicating switch the module with the output of PLC controller links to each other. The utility model discloses when can provide a pressure that lightens the rush-hour.

Chinese Patent CN105957357 discloses a novel intelligent traffic light control system comprising traffic light terminals arranged at all intersections, pressure sensing information acquisition systems arranged at light waiting zones, emergency terminals, and a monitoring center. The pressure sensing information acquisition systems consist of pressure sensing devices and second communication circuits. The emergency terminals include emergency buttons, cameras and third communication circuits. The monitoring center is used for obtaining road passing control information according to light waiting pedestrian number information and road condition information that are collected in real time. With the system, traffic dispersion can be carried out reasonably according a road condition, so that the traffic operation becomes smooth and efficient and thus the traffic pedestrian passing accident rate can be reduced effectively.

Chinese Utility Model Patent CN205582271 discloses an intelligent transportation lamp system based on dynamic flow monitoring. Including driveway intelligent transportation lamp system, pavement intelligent transportation lamp system, characterized by: driveway intelligent transportation lamp system. The utility model discloses a real-time supervision car, flow of the people situation can be passed through to characteristics, come intelligent control crossroad's traffic light time delay, have improved the operating efficiency of urban traffic road network.

Chinese Patent CN105788302 discloses a dual-target-optimization-based dynamic timing method for an urban traffic signal lamp. The method comprises: a green time ratio, maximum green light time, minimum green light time, and a signal cycle T of an intersection are designated primarily and a conversion step length B is designated; during the given signal cycle T, a green light signal of the intersection is turned on successively according to a phase; traffic data at the intersection are monitored in real time, and a green light phase vehicle queuing length p and a vehicle queuing length q of a next green light phase of the intersection are calculated, and a fuzzy logic controller adjusts green time ratios u of all phases of the intersection in real time

Chinese Patent CN105608914 discloses a traffic control system based on traffic flow, includes a real time monitoring device, traffic lights and a calculation unit, wherein the real time monitoring device includes a traffic flow monitoring device which is used for detecting the traffic flow, and a traffic light control device which is used for communicating with the traffic lights; the calculation unit is used for calculating the real-time traffic status according to the result monitored by the traffic flow monitoring device, outputting a signal to the traffic light control device according to the real-time traffic status, and controlling the display state of the display light of each channel of the traffic lights; and the real-time traffic status includes the vehicle flow information of the crossing at which the traffic lights exist, a road segment S1 from an upstream crossing of the crossing at which the traffic lights exist to the crossing at which the traffic lights exist, and a road segment S2 from the crossing at which the traffic lights exist to a downstream crossing of the crossing at which the traffic lights exist.

Chinese Utility Model Patent CN205211172 discloses an intelligent transportation lamp control system based on GPRS control, which comprises a monitoring center, the surveillance center is provided with man-machine interface, man-machine interface is connected with data processor, GPRS network management ware and memory B, the surveillance center is connected with the signal transmission basic station, the signal transmission basic station is connected with the monitor, the internally mounted of monitor has the treater, the treater is connected with power and AD converter, the AD converter is connected with sensor and traffic light, the treater is connected with the GPRS data transmission module, the GPRS data transmission module is connected with the high in the clouds server, the high in the clouds server is connected with intelligent terminal, to control the lamp in function calculated traffic flow.

Chinese Patent CN104916066 discloses a traffic intersection signal lamp adaptive control system. The control system comprises a plurality of cameras, a plurality of signal lamp controllers and a remote monitoring platform, wherein the cameras and the signal lamp controllers are in one-to-one correspondence, each camera is correspondingly connected to one signal lamp controller and used for shooting an intersection where signal lamps controlled by the corresponding signal lamp controller are located so as to acquire intersection images, the signal lamp controllers carry out compression coding and UDP (user datagram protocol) packaging on the intersection images so as to output intersection image network data, and the remote monitoring platform is connected to the plurality of signal lamp controllers through a 4G network so as to acquire network data of a plurality of intersection images and carries out adaptive control on a plurality of signal lamps controlled by the plurality of signal lamp controllers based on the network data of the plurality of intersection images. Through the traffic intersection signal lamp adaptive control system, the traffic light duration time of the signal lamps of the plurality of intersections can be determined adaptively according to specific passage conditions of a plurality of intersections of the same road section, thereby realizing reasonable scheduling of the traffic flow.

Chinese Patent CN104282159 discloses an urban traffic fuzzy coordination control system based on a Zigbee and a computer. The urban traffic fuzzy coordination control system based on the Zigbee and the computer is composed of a central monitoring center, multiple sub-region monitoring centers and multiple signal monitors. Each sub-region monitoring center comprises a wireless relay and a sub-region monitor. Each signal monitor comprises a Zigbee communication module, a vehicle information collector, a microprocessor and a traffic light.

Chinese Patent CN103366585 discloses a wireless sensor network-based self-adaptive traffic light control system. Sensor nodes which are laid on the road surfaces and provided with ultrasonic transceiver modules are used for detecting traffic flow on lanes of various directions, and the vehicle release time of the corresponding lane is changed in real time according to the traffic flow. The system comprises an integrated controller, wireless sensor nodes and signal lights, wherein the integrated controller plays a role of a SinkNode in a wireless sensor network, data collected by each node is converged to the integrated controller, the integrated controller communicates with the wireless sensor nodes, operating a scheduling algorithm, controls the signal lights, and communicates with a remote monitoring computer.

Chinese Patent CN103337161 discloses an optimization method of an intersection dynamic comprehensive evaluation and signal control system based on a real-time simulation model. Statistical analysis is performed on an intersection vehicle arrival time distribution law and a saturation time headway distribution law, simulation control is performed on vehicles monitored in real time, analytical calculation of traffic flow parameters of an intersection such as mean queue length, queue time and travel vehicle speed, and characteristics such as vehicle exhaust, oil consumption and noise, and acquired information is shared and an optimized signal control scheme is implemented by a third party control platform.

Chinese Utility Model CN202120450 discloses a traffic flow traffic light control system. The system is characterized in that the system comprises a traffic flow monitoring subsystem, a data processing subsystem, and a traffic lights control subsystem; the traffic flow monitoring subsystem is connected with the data processing subsystem, and the data processing subsystem is connected with the traffic lights control subsystem; and the traffic flow monitoring subsystem comprises monitoring cameras distributed on the road and a traffic flow control module. In the system, the staying time of traffic lights of each direction of a crossroad can be reasonably distributed according the traffic flow, the time utilization rate is increased.

Chinese Patent CN1928948 discloses an urban road traffic block detection and alarm system that comprises: a vehicle detector, a traffic signal control system, and the analysis and alarm computer with corresponding database and program. Wherein, it first builds the state monitor list for vehicle detector, real-time modifies the list according to received current traffic light stage and the detector state; then, it analyzes the data in list to send block alarm for that the detection time window is occupied continually from the green light to alarm threshold time, or cancels the alarm for the detection time window frees more than 3s from the green light to alarm threshold time.

The disclosures of the aforementioned patents, although they have brought an evolution, still present limitations, disadvantages and drawbacks in the area of traffic flow control of vehicles in intersected roads, such as:

a) Current state-of-the-art patents rely on local cameras and sensors that, with varying degrees of precision, can only estimate momentary or past vehicle flows, and can only act on data from events already are not predictive systems of future flows, since they have no connection with predictive sources of probability of high occurrence, such as routes already planned by users, exit already occurred or planned emergency vehicles, events already scheduled, and others, which are now available in the form of cloud data and extensive Internet networks;

b) Most patents have local controls, which operate under the calculated flow for a certain intersection, with no correlation with other traffic lights where vehicles on the road are expected to pass or are more likely to pass along their paths;

c) Even when presenting systems that manage a network of traffic lights correlating multiple local information, current patents do not have information provided by any system that contains predictive information such as weather or weather forecasts, user predicted routes, transit prediction of priority users, such as emergency vehicles, public safety, disabled and others;

d) None of the currently developed systems leverages the immense amount and quality of data available on the Internet, and in particular networks of application managers, social networks, and others;

e) Existing or proposed patent systems are not using, alongside the Internet and Internet networks, the immense platform of personal computers and existing mobile devices, being only subject to the reactive information coming from diverse types of sensors locations.

f) None of the current systems employs advanced artificial intelligence methods, such as “machine learning” for continuous and automated system optimization

“PREDICTIVE, INTEGRATED AND INTELLIGENT SYSTEM FOR CONTROL OF TIMES IN TRAFFIC LIGHTS” was developed to solve the disadvantages, drawbacks and limitations of the current systems of time control in traffic lights, as it presents the integrated concept of traffic management through the simultaneous use of emerging technologies, namely: monitoring of crowdsourcing/big data information (traffic, climate, events, holidays, works, among others), intelligent and trainable decision-making algorithms based on “Machine Learning” and “IoT” (internet of things). This center, based on artificial intelligence and big data, interacts with traffic lights, “VMSs”, Smartphones, personal systems (computers, tablets, among others), WEB systems among others, but not limited to them, to create a dynamic, intelligent and truly predictive of control of vehicular flow and of people so that these can move intelligently by the public ways.

The system has advantages of also informing the users of the public roads, through Variable-Message Signs, personal cellular systems, among others, the traffic conditions in each place, as well as the best route to its destination, and also interacts with emergency public service vehicles (police, ambulances, firemen, among others), to know their origin and destination, giving them the best possible route and commanding the vehicles that are on the route defined to seek alternative routes to the as the emergency vehicle approaches. This allows lives to be saved, since these vehicles will have their paths clear of normal traffic. The system allows to improve the fluidity of vehicles, pedestrians and emergency vehicles on public roads, using information available from crowdsourcing data (“Waze”, “Google Maps”, etc.).

The problems presented in the state of the art, and which the present patent has resolved, are as follows:

A. Current time calculation systems work through past data analyses such as number of vehicles detected and vehicle volume history in the last hours, days or months rather than what will happen soon enough. These historical data, or based only on the detections of the volume of vehicles at each intercession, are extremely inefficient for calculating traffic lights when there is any change in the environment (rain, track work, accident, maintenance involving total or partial obstruction, volume of vehicles not considered in history, among others). This problem is solved in the present patent through the simultaneous use of emerging technologies, namely: monitoring of information crowdsourcing (traffic, climate, events, holidays, works, among others), intelligent algorithms and decision-makers based on “Machine Learning” and “IoT” (internet of things). This center, supported by artificial intelligence and big data, will interact with traffic lights, “VMSs”, “Smartphones”, personal systems (computers, tablets, among others), WEB systems, among others, but not limited to them, to create a system dynamic, intelligent and really predictive of control of vehicular flow and of people so that these can move intelligently by the public ways.

B. Current systems use physical and local sensors, such as piezoelectric sensors, cameras, vehicle counters, etc., that generate a complex processing for data treatment, and imply in the treatment of data for only corrective actions of the behavior. This problem is solved in the present patent by predictive system which counts on previous information of future events for accurate prediction of traffic control.

C. Current systems do not have bidirectional communication, that is, the information collected, mainly from the flow of vehicles, do not give the driver feedback on better routes, nor do they prioritize the opening of traffic lights for a longer time on the alternative routes when there is some obstruction or bottling on the route intended by the user. This problem is solved in the present patent through bidirectional communication with the user.

D. Current semaphore time control systems do not have the ability to interact with emergency vehicles and other vehicles to prioritize the passage of these life-saving vehicles. This problem is overcome by the present patent, because the system interacts with emergency public service vehicles (police, ambulances, firemen, among others) whenever possible to create a green wave along the mute traveled by the vehicle. Through app and web system, to know its origin and destination, the best possible route will be calculated and guiding the vehicles present in the defined route to look for alternative ways as the emergency vehicle approaches.

E. Current systems do not take into account and do not support people with special needs, especially those who have difficulty in locomotion, hearing and vision, only have a sound system informing the traffic light status, which is extremely ineffective if the person with special needs has difficulty on hearing and vision, or locomotion, because there is no feedback that is perceptible to users who have both visual and hearing impairments, and there is also no change in the pedestrians traffic light for those who have difficulty on locomotion. The system of the present patent has solved this problem, since these users can register in the system as having these deficiencies, and whenever they indicate their destination, the system will accompany their displacement, sending feedback (vibration and sound), in their “smartphone” informing the state of the traffic light to facilitate its crossing. In special cases, the disabled person can report their difficulty of movement, in these cases, whenever the user arrives near a traffic light the system will calculate a greater time so that it can cross with greater security.

The solution proposed here is based on a set of technologies that allows to generate a better flow of traffic. From polls by drivers, cyclists, pedestrians to the adoption of intelligent traffic lights; passing through statistical analysis related to holidays, events, climates; reinforcing with information from crowdsourcing apps such as “Waze”, “Google Maps” and others consolidating all this information into an adaptive and flexible solution based on the application of Machine Learning/Artificial Intelligence techniques, which will allow the system learns and self-tuning throughout the operation. It will also solve the major problem of the circulation of emergency vehicles, allowing them to circulate more efficiently on urban roads. It will also support the disabled, mainly those who have difficulty in locomotion, hearing and vision, but not limited to them, that is, these users can register in the system as having these deficiencies, and whenever they indicate their destination the system will follow the by sending feedbacks on your smartphone, informing you of the state of the traffic light to facilitate your crossing. In special cases, the disabled person can report their difficulty of movement, in these cases, whenever the user arrives near a traffic light the system will calculate a greater time so that it can cross with greater security. The current systems have only one sound system informing the traffic light status, which is extremely inefficient if the person with special needs has difficulty hearing and vision or locomotion, since there is no feedback that is perceptible by users who have both the visual and hearing impairments, and there is also no change in pedestrian traffic light for those who have difficulty locomotion.

The problem of the circulation in public roads is the search for a solution that really allows reconciling the several factors and “actors” that use and demand necessities in the traffic of the cities and even in highways, has been a challenge with which the author has come across over the years. After studying the most different systems and seeing that their application did not contribute significantly to solve the problem of urban mobility, being one of the main reasons for the dissatisfaction of public road users and public agents at all levels (managers, technicians and operators), the author sought ways to break the established paradigm and use the available technological means, combined with the development of new technologies and algorithms to solve the problem of not knowing in advance what will happen on public roads and how we can act when each event happens.

The project stalled with the idea of creating a smart autonomous semaphore, where it would use “crowdsourcing” data from “Waze”/“Google Maps” to automatically adjust itself according to the flow of vehicles in each route, prioritizing the way with greater movement at a given moment. When studying and deepening the subject, it was visualized the possibility of extending the concept to an Intelligent Control Center for Traffic. One of the great difficulties was how to develop algorithms to optimize traffic in an integrated way, so it was decided to study and develop systems based on Artificial Intelligence and it was realized that this technique, combined with the use of information crowdsourcing data (traffic, climate, events, holidays, works, among others), intelligent algorithms of decision making, and supported in Machine Learning, IoT, and Big Data could be the key to the construction of solution. Thus, the system could learn from the data and over time, continuously improving traffic optimization.

For a better understanding of the present invention, the following figures are attached:

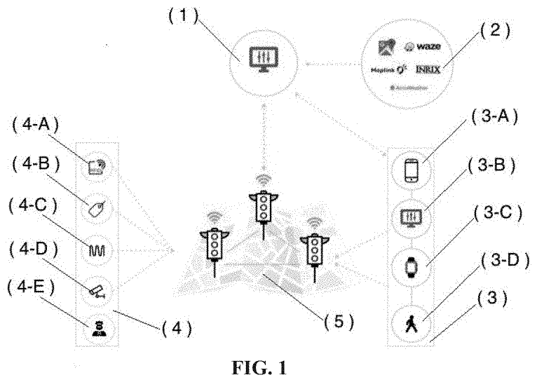

FIG. 1, showing schematic diagram of the interconnection of the Intelligent Control Center with the components of the system object of the present invention;

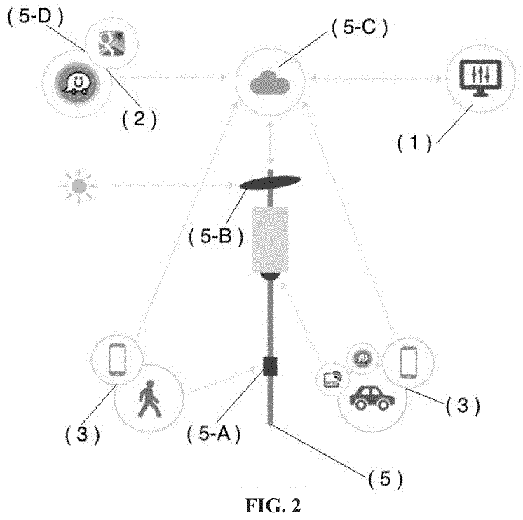

FIG. 2, showing schematic diagram of an intelligent traffic light, its flow of operations and interconnection with the components of the system object of the present invention;

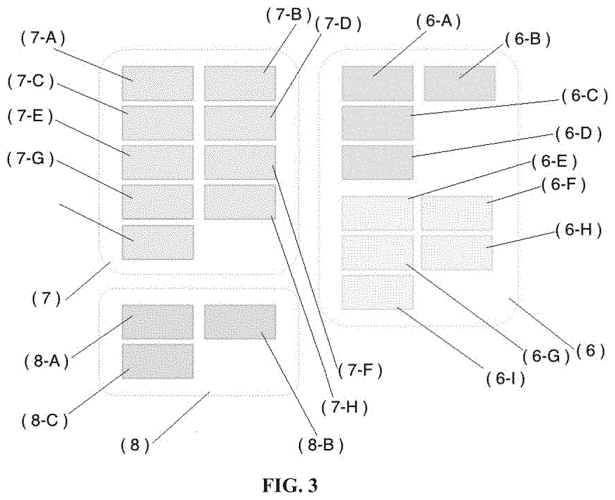

FIG. 3, which shows a block diagram by solution domain, including control intelligence domain, data acquisition domain and system signaling domain on the present patent;

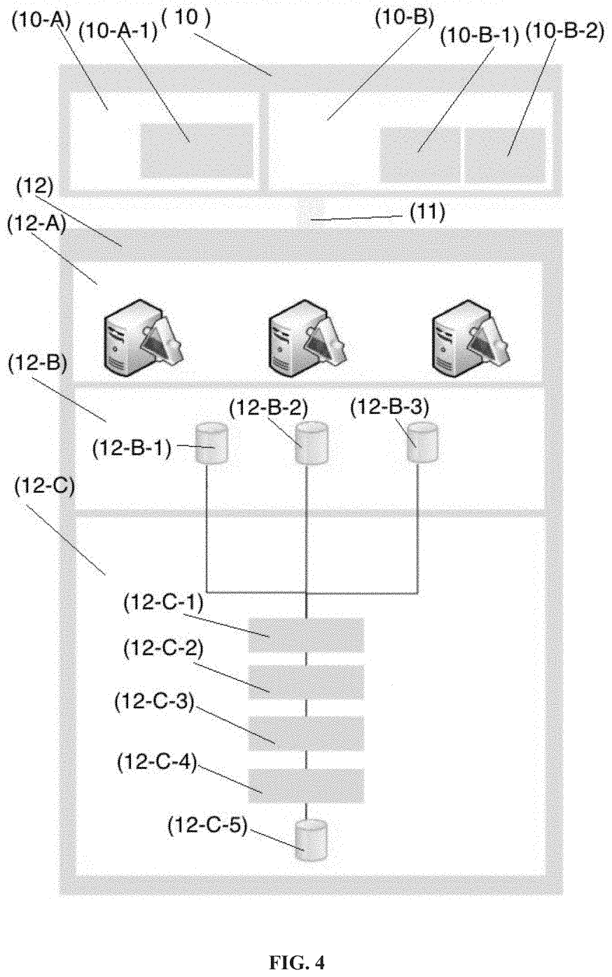

FIG. 4, showing a flowchart of the software architecture of the control system with the aim of presenting the operating environment and technologies that will be employed to implement and operate the solution by the present patent;

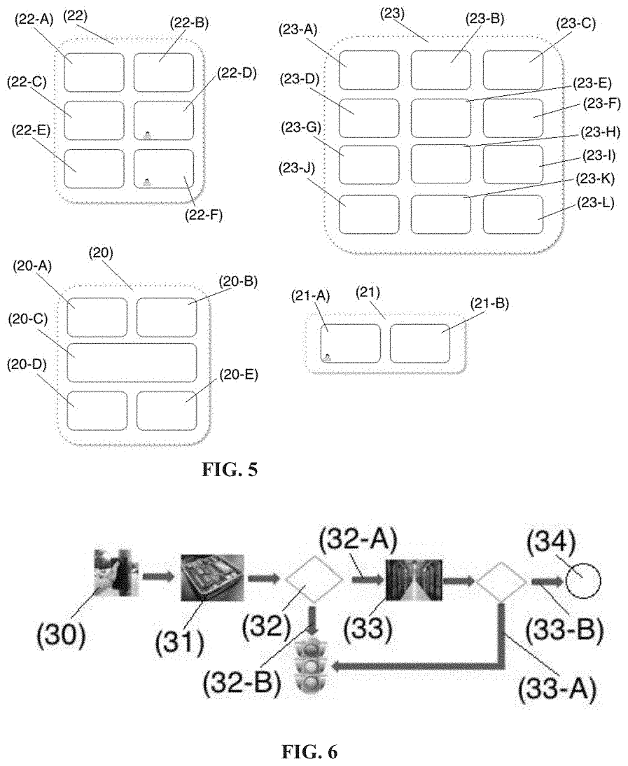

FIG. 5, which shows functional diagram of the software associated with the Intelligent Control Center, the Proprietary Applications, and the Intelligent Traffic Light, objects of the present patent; and

FIG. 6, which shows the operation diagram of the Biometric Recognition System (“BioID”) contained in the Intelligent Traffic Light of the Traffic Control System object of the present patent.

According to FIGS. 1 and 2, the traffic light timing system object of the present patent is composed of Intelligent Traffic Control Center (1) composed of system and application hardware and software and proprietary softwares which do all the data processing from the data sources obtained by collective collaboration (crowdsourcing) of information (traffic, climate, events, holidays, works, among others) using intelligent algorithms of decision making and supported by “Machine Learning”, “Internet of Things” (“IoT”), and “Big Data” to define the time of each traffic light on the system and to send feedback to users (vehicles, pedestrians and emergency vehicles) with traffic information and instructions in traffic circulation; Existing source of “crowdsourcing” applications (2) such as “Google Maps”, “Google Earth”, “Waze”, “AccuWeather”, “Climatempo”, “Maplink”, and others providing data In unilateral communication with the Intelligent Transit Center (1); A proprietary application system (3) comprising smartphone applications for the pedestrian and driver (3-A), personal computer applications (3-B), wearable applications (3-C), and applications for local physical interaction (3-D) of the Intelligent Traffic Light (5), among other applications for mobile devices, but not limited to them, the proprietary applications (3) being in bilateral communication with the Intelligent Center (1), and in unilateral communication with the network of intelligent autonomous traffic lights (5), which proprietary applications (3) allow users to interact with traffic lights through the Intelligent Traffic Control Center (1) to inform their destination and route, request installing new systems and receiving feedback from the system; Local communication interfaces (4) of intelligent autonomous traffic lights (5) with the other communication systems with road users, with data coining from devices such as radio frequency identification (RFID) tags (4-A), pre-registered users prioritization tags (“non-stop” systems) (4-B), data from magnetic loops (4-C), information coming from security cameras and vision systems for reading car license plates (4-D), and traffic violation surveillance systems (4-E), but not limited to them, all interfaces (4) being in unilateral communication with intelligent autonomous traffic lights (5); Intelligent autonomous traffic lights (5), which communicate in a network with each other, and which have bilateral communication with the intelligent control center (1), the traffic lights (5) also containing the pedestrian priority identification system (5-A), equipped with a personal recognition system such as fingerprint or any other biometric recognition and local activation buttons, where the disabled and the elderly can have their fingerprints or other biometric data registered in the system for recognition and prioritization of them in the crossing, and which communicates with the traffic light for priority opening of the signal, the traffic light (5) being powered by autonomous electrical energy, coming front the solar signal (5-B), and being in unilateral communication with the source of “crowdsourcing” applications (2) through the Internet data cloud (5-C), through Application Programming Interfaces (“APIs”) (5-D) which process data from crowdsourcing applications (2) through Machine Learning algorithms, and calculate predictions of future traffic flows and events, to enable Intelligent Central (1) to act in a predictive way on the performance of the signals of the intelligent traffic lights (5), the intelligent traffic lights (5) being in unilateral communication with the pedestrian proprietary application (3), which can request the opening of traffic lights on the way, report errors or localized events such as accidents, or manually activate the button at the local intelligent traffic light button (5), while the traffic lights (5) are in unilateral communication with the driver proprietary application (3), which is in unilateral communication with the Internet data cloud (5-C), to, in bilateral communication with the intelligent control center (1), receive warnings about road conditions, report defects and accidents, and vote for a longer opening time of traffic light in congested roads, while the driver (5-D), in unilateral communication with the intelligent traffic light (5) provides system with information through radio frequency identifiers (“RFIDs”). Intelligent autonomous traffic lights (5) can also act autonomously in relation to the Intelligent Central (1), in case of loss of communication, as they contain their own local software and communication system, in order to receive information from users, pedestrians, drivers, authorities, by acting locally of the “APIs” (5-D), and to carry out the autonomous control of the traffic lights according to this information.

According to FIG. 3, we have a block diagram of the different domains of the solution, these being the Data Acquisition Domain (6), which contains the application programming interfaces (“APIs”) components responsible for collecting a large amount of data (“big data” and “crowdsourcing”) from various information sources: through the Interface with Navigation Systems (6-A), collects data with systems such as “Waze”, “Google Maps”, “Google Earth”, and others, through the Social Networks Interface (6-B), collects data from social networks such as “Facebook”, “Twitter”, and others, through the Climate Information Interface (6-C) collects data from weather information networks such as “Meteorological Radar”, “Climatempo”, “Accuweather” and others, through the Radar and Camera interface (6-D) collects data from radar and cameras for flow control and identification of vehicles; Data Acquisition Domain also collects information from the various applications made available by the system, such as the driver application (6-E), the disabled application (6-F), the pedestrian application (6-G), the traffic agent application (6-H) and the cyclist application (6-I), Intelligence and Control Domain (7), which contains the components of the Intelligence and Operative Center from the Traffic Control Center (1), which process in real time all the data being collected and apply the algorithms of “machine learning” to optimize, prioritize, inform and command the signaling, such modules being: a module in normal operation (7-A), which acts in cases of system shutdown or reprogramming of the parameters of the algorithms, by shutting down the artificial intelligence system, where the system re-operates in a conventional way with predefined time parameters, predictive module (7-B), responsible for predicting future situations and preparing the system in advance for traffic jam peaks due to events, weather conditions, traffic accidents, and others, optimization module (7-C), which activates in real time the traffic lights and “VMSs” in order to optimize the traffic at all times, priorities module (7-D), which receives information from applications (disabled, agents, security entities) to interfere with algorithms and obtain priorities for these situations, configurator module (7-E), which is the managing environment from the Intelligence System which allows for registry of agents, managers, parameters and all other necessary configuration, Training Module (7-F), used to teach machine learning algorithms to optimize traffic, measurement and statistical module (7-G), which monitors and stores the history of relevant system indicators, environment measurements in normal mode, measurement of environment and of the various intersections in artificial intelligence mode, event scheduling module (7-H), which collects data on scheduled events that impact the flow of vehicles, and in which all reprogramming will be recorded allowing the extraction of various information, reports and decisions (“Business Intelligence”), and finally the “dashboard” module (7-I) that is the message board to inform the operation of the Traffic Intelligence Center in real time, presenting statistics, traffic jams, system decisions, status of the various modules, traffic lights, “VMSs”, and other information necessary for operators to have a clear view of how the system is operating; Signaling Domain (8), which contains the component modules responsible for interfacing with traffic lights, “VMSs” and security and emergency entities, allowing the Intelligent Control Center (1) to control the reprogramming of opening and closing times of each traffic light in the network module through the decisions derived from the processing of the various data obtained, at any time, the modules of the signaling domain: interface with the traffic lights module (8-A), which activates the intelligent traffic lights (5), interface module with the “VMSs” (8-B), which displays the messages triggered by the intelligent control panel (1), interface with the security authorities module (8-C), whereby the intelligent control unit (1) identifies anomaly by the behavior of a driver, pedestrian or vehicle and inform them to the safety authorities, who can connect to the system through available “APIs”.

According to FIG. 4, the software architecture used by the Intelligent Traffic Control Center (1), presents the following layers: Presentation Layer (10), which uses, in order to present the applications of “World Wide Web” (10-A) for front-end presentation, framework software (10-A-1), such as AngularJS or similar, and for front-end presentation of applications on mobile platforms (10-B) uses Android (10-B-1) or iOS (10-B-2) or similar operating system to create native or hybrid frameworks; Transfer of state (11) from the presentation layer (10) to the infrastructure layers and services in the cloud (12) through architectural style “REST” (Representation Estate Transfer); infrastructure and Services Layers in the Cloud (12), which consist of: service layer (12-A), consisting of application servers, data layer (12-B), which employs “nonSQL” scalable data, bank (12-B-1) such as “MongoDB” or similar, data logging (12-B-2) and other data sources (12-B-3); And Machine Learning Layer (12-C), where non-treated data (12-C-1) are extracted and have their characteristics analyzed by algorithm (12-C-2), said characteristics interpreted by Machine Learning algorithms (12-C-3), which generates a Model (12-C-4), which allows a Prediction on Future Data (12-C-5).

According to FIG. 5, the software of the traffic control system object of the present patent consists of: System (20) of the Intelligent Traffic Control Center (1), which performs the functions of Integration with the “crowdsourcing” solutions (20-A), Integration with third-party systems (20-B), for traffic monitoring, inspection, among other functions of third parties such as public agencies, Information processing and storage (20-C) received through “Machine Learning” algorithms, “Internet of Things”, “Big Data” algorithms, and others, Generating and sending alerts (20-D) to Variable-Message Signs (“VMSs”), and to users through SMS messages, e-mails, and other forms, and Optimization of traffic lights (20-E) according to the processing and analysis of the data; Local software (21) of the Intelligent Traffic Lights (5), which performs the functions of priority opening by local request of crossing by pedestrian or disabled (21-A), and Reception of information (21-B) with consequent adjustment of traffic lights; Local software (22) of End-User Applications (6-E), (6-F), (6-G), (6-H), and (6-I), which performs the Receiving of Request for Priority (emergencies) and route information to be prioritized (22-A), Display of traffic alerts (22-B), Request for installation and submission of improvement suggestions (22-C), change of opening and closing times of traffic lights (22-D) by traffic system controllers or traffic agents, event or incident information (22-E), and dashboard view (22-F) by traffic system controllers; and System Administrator application software (23) in the Intelligence and Control domain (7), which performs the functions of Traffic Map Display (23-A), configuration of Machine Learning parameters (23-B), “Machine Learning” Deactivation (23-C) in case of option for normal operation in module (7-A), Machine Learning change alert display (23-D), Parameter setting algorithms (23-E), Configuration of default traffic light time (23-F) in case of normal operation, Generation of reports (23-G), Visualization of indicators (23-H), Configuration of prioritization (23-I), Management of users (23-J), Permissions Management (23-K), and General System Settings (23-L).

According to FIG. 6, the “BioID” biometrics local user identification device contained in the pedestrian priority identification system (5-A) from the intelligent traffic light (5) operates as follows:

a) Whenever the traffic light is red for pedestrian, the fingerprint reader hardware or other biometric system (“BioID”) is waiting for the information of a biometric characteristic corresponding to a pedestrian (30) who wants to cross a traffic lane. This process will be inhibited when the traffic light is green (free) for pedestrians.

b) Whenever the biometric reader does the recognition of the individual, it sends the information with the ID (coding generated for each individual) to the request control board (31), which verifies through a logical decision algorithm (32) whether the traffic light (5) is online with the Traffic Lights Center (33) or not. If the traffic light is online, the logical decision is “Yes” (32-A), and the card sends the information from the digital to the Traffic Lights Center (33) to verify the consistency of the identification (positive (33-A) or negative (33-B)) according to some criteria such as: time between requests (BioID reading), comparison with previous repetitions (more than one reading in sequence, indicating that they may be different information from the same user), contact temperature (indicating that they may be different fingers of the same user, in case of fingerprint reading), among others, but not limited to them.

c) In the case of a positive identification (33-A), the traffic light control software (33) commands the traffic light controller (34) to change the traffic light times in order to give pass to pedestrian.

d) In case of negative identification (33-B), the software of the Traffic Center (33) discards the read digital and requests the user to re-identify (34).

e) If the traffic light is off-line with the Traffic Light Center (33), the requisition control board (31) checks whether the amount of positive readings has reached the amount set in the pre-configured parameters in the system, sending to the traffic light controller the priority request. The priority request may be scalable depending on the number of requests requested, i.e. for a single user the priority is less than a set of requests from multiple users.

f) The configuration of these parameters may be local, made by the traffic agent, or remote, through Control Center (1), when the traffic light is connected to the Control Center.

g) It is important to point out that the process of changing the traffic lights for prioritization of the pedestrian crossing will be performed by the traffic light controller (5) or by the Traffic Lights Center, the biometric reading system (BioID) will only indicate to the controller or the Traffic Light Center the request indicator checked by the system.

1. “PREDICTIVE, INTEGRATED AND INTELLIGENT SYSTEM FOR CONTROL OF TIMES IN TRAFFIC LIGHTS”, characterized by, Intelligent Traffic Control Center (1) composed of system and application hardware and software and proprietary software which do all the data processing from the data sources obtained by collective collaboration (crowdsourcing) of information (traffic, climate, events, holidays, works, among others) using intelligent algorithms of decision making and supported by “Machine Learning”, “Internet of Things” (“IoT”), and “Big Data” to define the time of each traffic light on the system and to send feedback to users (vehicles, pedestrians and emergency vehicles) with traffic information and instructions; Existing source of “crowdsourcing” applications (2) such as “Google Maps”, “Google Earth”, “Waze”, “AccuWeather”, “Climatempo”, “Maplink”, and others providing data in unilateral communication with the Intelligent Transit Center (1); A proprietary application system (3) comprising smartphone applications for the pedestrian and driver (3-A), personal computer applications (3-B), wearable applications (3-C), and applications for local physical interaction (3-D) of the Intelligent Traffic Light (5), among other applications for mobile devices, but not limited thereto, the proprietary applications (3) being in bilateral communication with the Intelligent Center (1), and in unilateral communication with the network of intelligent autonomous traffic lights (5), which proprietary applications (3) allow users to interact with traffic lights through the Intelligent Traffic Control Center (1) to inform their destination and route, request installing new systems and receiving feedback from the system; Local communication interfaces (4) of intelligent autonomous traffic lights (5) with the other communication systems with road users, with data coming from devices such as radio frequency identification (RFID) tags (4-A), pre-registered users prioritization tags (“non-stop” systems) (4-B), data from magnetic loops (4-C), information coming from security cameras and vision systems for reading car license plates (4-D), and traffic violation surveillance systems (4-E), all interfaces (4) being in unilateral communication with intelligent autonomous traffic lights (5); Intelligent autonomous traffic lights (5), which communicate in a network with each other, and which have bilateral communication with the intelligent control center (1), the traffic lights (5) also containing the pedestrian priority identification system (5-A), equipped with a personal recognition system such as fingerprint and biometric recognition and local activation buttons, and which communicates with the traffic light for priority opening of the signal, the traffic light (5) being powered by autonomous electrical energy, coming from the solar signal (5-B), and being in unilateral communication with the source of “crowdsourcing” applications (2) through the Internet data cloud (5-C), through Application Programming Interfaces (“APIs”) (5-D) which process data from crowdsourcing applications (2) through Machine Learning algorithms, and calculate predictions of future traffic flows and events, to enable Intelligent Central (1) to act in a predictive way on the performance of the signals of the intelligent traffic lights (5), the intelligent traffic lights (5) being in unilateral communication with the pedestrian proprietary application (3), which can request the opening of traffic lights on the way, report errors or localized events such as accidents, or manually activate the button at the local intelligent traffic light button (5), while the traffic lights (5) are in unilateral communication with the driver proprietary application (3), which is in unilateral communication with the Internet data cloud (5-C), to, in bilateral communication with the intelligent control center (1), receive warnings about road conditions, report defects and accidents, and vote for a longer opening time of traffic light in congested roads, while the driver (5-D), in unilateral communication with the intelligent traffic light (5) provides system with information through radio frequency identifiers (“RFIDs”).

2. “PREDICTIVE, INTEGRATED AND INTELLIGENT SYSTEM FOR CONTROL OF TIMES IN TRAFFIC LIGHTS”, according to claim 1, characterized by, Intelligent autonomous traffic lights (5) which can also act autonomously in relation to the Intelligent Central (1), in case of loss of communication, in order to receive information from users, pedestrians, drivers, authorities, by local action of the “APIs” (5-D), and to carry out the autonomous control of the traffic lights according to this information.

3. “PREDICTIVE, INTEGRATED AND INTELLIGENT SYSTEM FOR CONTROL OF TIMES IN TRAFFIC LIGHTS”, according to claim 1, characterized by, system being managed in the following domains: Data Acquisition Domain (6), which contains the application programming interfaces (“APIs”) components responsible for collecting a large amount of data (“big data” and “crowdsourcing”) from various information sources: through the Interface with Navigation Systems (6-A), collects data with systems: “Waze”, “Google Maps”, “Google Earth”, and others, through the Social Networks Interface (6-B), collects data from social networks such as “Facebook”, “Twitter”, and others, through the Climate Information Interface (6-C) collects data from weather information networks such as “Meteorological Radar”, “Climatempo”, “Accuweather” and others, through the Radar and Camera Interface (6-D) collects data from radar and cameras for flow control and identification of vehicles; Data Acquisition Domain also collects information from the various applications made available by the system, such as the driver application (6-E), the disabled application (6-F), the pedestrian application (6-G), the traffic agent application (6-H) and the cyclist application (6-I); Intelligence and Control Domain (7), which contains the components of the Intelligence and Operative Center from the Traffic Control Center (1), which process in real time all the data being collected and apply the algorithms of “machine learning” to optimize, prioritize, inform and command the signaling, such modules being: a module in normal operation (7-A), which acts in cases of system shutdown or reprogramming of the parameters of the algorithms, by shutting down the artificial intelligence system, where the system re-operates in a conventional way with predefined time parameters, predictive module (7-B), responsible for predicting future situations and preparing the system in advance for traffic jam peaks due to events, weather conditions, traffic accidents, and others, optimization module (7-C), which activates in real time the traffic lights and “VMSs” in order to optimize the traffic at all times, priorities module (7-D), which receives information from applications: disabled, agents, security entities, and similar, to interfere with algorithms and obtain priorities for these situations, configurator module (7-E), which is the managing environment from the Intelligence System which allows for registry of agents, managers, parameters and all other necessary configuration, Training Module (7-F), used to teach machine learning algorithms to optimize traffic, measurement and statistical module (7-G), which monitors and stores the history of relevant system indicators, environment measurements in normal mode, measurement of environment and of the various intersections in artificial intelligence mode, event scheduling module (7-H), which collects data on scheduled events that impact the flow of vehicles, and in which all reprogramming will be recorded allowing the extraction of various information, reports and strategic decisions supported by an ambient of Business Intelligence, and finally the “dashboard” module (7-I) to inform the operation of the Traffic Intelligence Center (1) in real time, presenting statistics, traffic jams, system decisions, status of the various modules, traffic lights, “VMSs”, and other information necessary for operators to have a clear view of how the system is operating; Signaling Domain (8), which contains the component modules responsible for interfacing with traffic lights, “VMSs” and security and emergency entities, allowing the Intelligent Control Center (1) to control the reprogramming of opening and closing times of each traffic light in the network module through the decisions derived from the processing of the various data obtained, at any time, the modules of the signaling domain being: interface with the traffic lights module (8-A), which activates the intelligent traffic lights (5), interface module with the “VMSs” (8-B), which displays the messages triggered by the intelligent control panel (1), interface with the security authorities module (8-C), whereby the intelligent control unit (1) identifies anomaly by the behavior of a driver, pedestrian or vehicle and inform them to the safety authorities, who can connect to the system through available “APIs”.

4. “PREDICTIVE, INTEGRATED AND INTELLIGENT PROCESS FOR CONTROL OF TIMES IN TRAFFIC LIGHTS”, according to claim 1, characterized by, software architecture used by the Intelligent Traffic Control Center (1), presenting the following layers: Presentation Layer (10), which uses, in order to present the applications of “World Wide Web” (10-A) for front-end presentation, framework software (10-A-1), such as AngularJS or similar, and for front-end presentation of applications on mobile platforms (10-B) uses Android (10-B-1) or iOS (10-B-2) or similar operating system to create native or hybrid frameworks; Transfer of state (11) from the presentation layer (10) to the infrastructure layers and services in the cloud (12) through architectural style “REST” (Representation Estate Transfer); Infrastructure and Services Layers in the Cloud (12), which consist of: service layer (12-A), consisting of application servers, data layer (12-B), which employs “nonSQL” scalable data bank (12-B-1) such as “MongoDB” or similar, data logging (12-B-2) and other data sources (12-B-3); And Machine Learning Layer (12-C), where non-treated data (12-C-1) are extracted and have their characteristics analyzed by algorithm (12-C-2), said characteristics interpreted by Machine Learning algorithms (12-C-3), which generates a Model (12-C-4), which allows a Prediction on Future Data (12-C-5).

5. “PREDICTIVE, INTEGRATED AND INTELLIGENT PROCESS FOR CONTROL OF TIMES IN TRAFFIC LIGHTS”, according to claim 1, characterized by, software of the traffic control system object of the present patent that consists of: System (20) of the Intelligent Traffic Control Center (1), which performs the functions of Integration with the “crowdsourcing” solutions (20-A), Integration with third-party systems (20-B), for traffic monitoring, inspection, among other functions of third patties such as public agencies, Information processing and storage (20-C) received, through “Machine Learning” algorithms, “Internet of Things”, “Big Data” algorithms, and others, Generating and sending alerts (20-D) to Variable-Message Signs (“VMSs”), and to users through SMS messages, e-mails, and other forms, and Optimization of traffic lights (20-E) according to the processing and analysis of the data; Local software (21) of the Intelligent Traffic Lights (5), which performs the functions of priority opening by local request of crossing by pedestrian or disabled (21-A), and Reception of information (21-B) with consequent adjustment of traffic lights timings; Local software (22) of End-User Applications (6-E), (6-F), (6-G), (6-H), and (6-I), which performs the Receiving of Request for Priority (emergencies) and route information to be prioritized (22-A), Display of traffic alerts (22-B), Request for installation and submission of improvement suggestions (22-C), change of opening and closing times of traffic lights (22-D) by traffic system controllers or traffic agents, event or incident information (22-E), and dashboard view (22-F) by traffic system controllers; and System Administrator application software (23) in the Intelligence and Control domain (7), which performs the functions of Traffic Map Display (23-A), configuration of Machine Learning parameters (23-B), “Machine Learning” Deactivation (23-C) in case of option for normal operation in module (7-A), Machine Learning change alert display (23-D), Parameter setting algorithms (23-E), Configuration of default traffic light time (23-F) in case of normal operation, Generation of reports (23-G), Visualization of indicators (23-H), Configuration of prioritization (23-I), Management of users (23-J), Permissions Management (23-K), and General System Settings (23-L).

6. “PROCESS OF WORKING FOR CONTROL OF TIMES IN TRAFFIC LIGHTS”, according to claim 1, characterized by, “BioID” biometrics local user identification device contained in the pedestrian priority identification system (5-A) from the intelligent traffic light (5) which operates as follows:
a) Whenever the traffic light is red for pedestrian, the fingerprint reader hardware or other biometric system (“BioID”) waits for the information of a biometric characteristic corresponding to a pedestrian (30) who wants to cross a traffic lane. This process will be inhibited when the traffic light is green (free) for pedestrians.
b) Whenever the biometric reader does the recognition of the individual, it sends the information with the ID (coding generated for each individual) to the request control board (31), which verifies through a logical decision algorithm (32) whether the traffic light (5) is online with the Traffic Lights Center (33) or not. If the traffic light is online, the logical decision is “Yes” (32-A), and the card sends the information from the digital to the Traffic Lights Center (33) to verify the consistency of the identification (positive (33-A) or negative (33-B)) according to some criteria such as: time between requests (BioID reading), comparison with previous repetitions (more than one reading in sequence, indicating that they may be different information from the same user), contact temperature (indicating that they may be different fingers of the same user, in case of fingerprint reading), and similar criteria;
c) In the case of a positive identification (33-A), the traffic light control software (33) commands the traffic light controller (34) to change the traffic light times in order to give pass to pedestrian.
d) In case of negative identification (33-B), the software of the Traffic Center (33) discards the read digital and requests the user to re-identify (34).
e) If the traffic light is off-line with the Traffic Light Center (33), the requisition control board (31) checks whether the amount of positive readings has reached the amount set in the pre-configured parameters in the system, sending to the traffic light controller the priority request. The priority request may be scalable depending on the number of requests requested, i.e. for a single user the priority is less than a set of requests from multiple users; and
f) The configuration of these parameters may be local, made by the traffic agent, or remote, through Control Center (1), when the traffic light is connected to the Control Center (1).
